(19) United States
(12) Patent Application Publication
(10) Pub. No.: US 2013/0062084 A1
(43) Pub. Date: Mar. 14, 2013

(54) AGRICULTURAL IMPLEMENT ROLLING BASKET SUPPORT

(71) Applicants: ROBERT T. CASPER, ANKENY, IA (US); SHAWN J. BECKER, ANKENY, IA (US); RICHARD J. CONNELL, SLATER, IA (US)

(72) Inventors: ROBERT T. CASPER, ANKENY, IA (US); SHAWN J. BECKER, ANKENY, IA (US); RICHARD J. CONNELL, SLATER, IA (US)

(21) Appl. No.: 13/232,484

(22) Filed: Sep. 14, 2011

(51) Int. Cl. A01B 35/28; A01B 35/16

(52) U.S. Cl. 172/540; 172/773

(57) ABSTRACT

A rolling basket support for coupling a rolling basket to an agricultural implement is disclosed. The rolling basket support includes a center portion having a bearing mount. A periphery extends radially around the bearing mount. The periphery has a radially inner notch for coupling to ground-engaging bars of a first cross-section and a radially outer notch for coupling to ground-engaging bars of a second cross-section.

### FIELD OF THE DISCLOSURE

The present disclosure generally relates to agricultural implements for conditioning soil, and more particularly to rolling basket supports for agricultural implements.

### BACKGROUND OF THE DISCLOSURE

In order to mount a rolling basket on an agricultural implement, agricultural implements commonly include rolling basket supports. The rolling basket supports have bearing mounts with a width such as stamped bearing flangettes or large multi-axis bearing mounts.

Rolling baskets usually include either round or flat ground-engaging bars extending transversely between the rolling basket supports. The bar type often determines the rolling basket support configuration. To change from one type of ground-engaging bar to another requires that the rolling basket supports be removed and replaced with different rolling basket supports. It is desired to provide a rolling basket design in which the rolling basket supports do not have to be replaced in order to change from one type of ground-engaging bar to another.

### SUMMARY OF THE DISCLOSURE

In one embodiment, a rolling basket support for coupling a rolling basket to an agricultural implement is disclosed. The rolling basket support includes a center portion having a bearing mount. A periphery extends radially around the bearing mount. The periphery has a radially inner notch for coupling to ground-engaging bars of a first cross-section and a radially outer notch for coupling to ground-engaging bars of a second cross-section.

In another embodiment, a rolling basket support for coupling a rolling basket to an agricultural implement is disclosed. The rolling basket support includes a center portion having a bearing mount. A plurality of spokes is coupled to the center portion. A periphery is coupled to the spokes. The periphery has a radially inner notch for coupling to ground-engaging bars of a first cross-section and a radially outer notch for coupling to ground-engaging bars of a second cross-section.

In yet another embodiment, an agricultural implement includes a coupling mechanism for coupling to a vehicle. A frame having a tool tube is coupled to the coupling mechanism and extends from the coupling mechanism. The frame is adapted to be pulled by the vehicle in a direction of travel. A plurality of wheel assemblies is coupled to the frame. The wheel assemblies support the frame above a surface. The agricultural implement includes a rolling basket having a rolling basket support for coupling the rolling basket to the tool tube. The rolling basket support includes a center portion having a bearing mount. A periphery extends radially around the bearing mount. The periphery has a radially inner notch for coupling to ground-engaging bars of a first cross-section and a radially outer notch for coupling to ground-engaging bars of a second cross-section.

### BRIEF DESCRIPTION OF THE DRAWINGS

FIG. 1 is a perspective view of an agricultural implement according to one embodiment.

FIG. 2 is a perspective view of a bearing portion of a prior art agricultural implement.

FIG. 3 is a side view of the bearing portion of the prior art agricultural implement of FIG. 2.

FIG. 4 is a perspective view of a rolling basket portion of a prior art agricultural implement.

FIG. 5 is a side view of the rolling basket portion of the prior art agricultural implement of FIG. 4.

FIG. 6 is a perspective view of a rolling basket support portion of the agricultural implement shown in FIG. 1.

FIG. 7 is a perspective view of a portion of a rolling basket of the agricultural implement shown in FIG. 1.

FIG. 8 is a front view of a rolling basket portion of the agricultural implement shown in FIG. 1.

FIG. 9 is a front view of a portion of a rolling basket of the agricultural implement shown in FIG. 1.

FIG. 10 is a perspective view of a portion of a rolling basket of an agricultural implement according to another embodiment.

FIG. 11 is a sectional view of a rolling basket support portion of the agricultural implement shown in FIG. 1.

Before any embodiments are explained in detail, it is to be understood that the disclosure is not limited in its application to the details of construction and the arrangement of components set forth in the following description or illustrated in the following drawings. The disclosure is capable of other embodiments and of being practiced or of being carried out in various ways.

### DETAILED DESCRIPTION

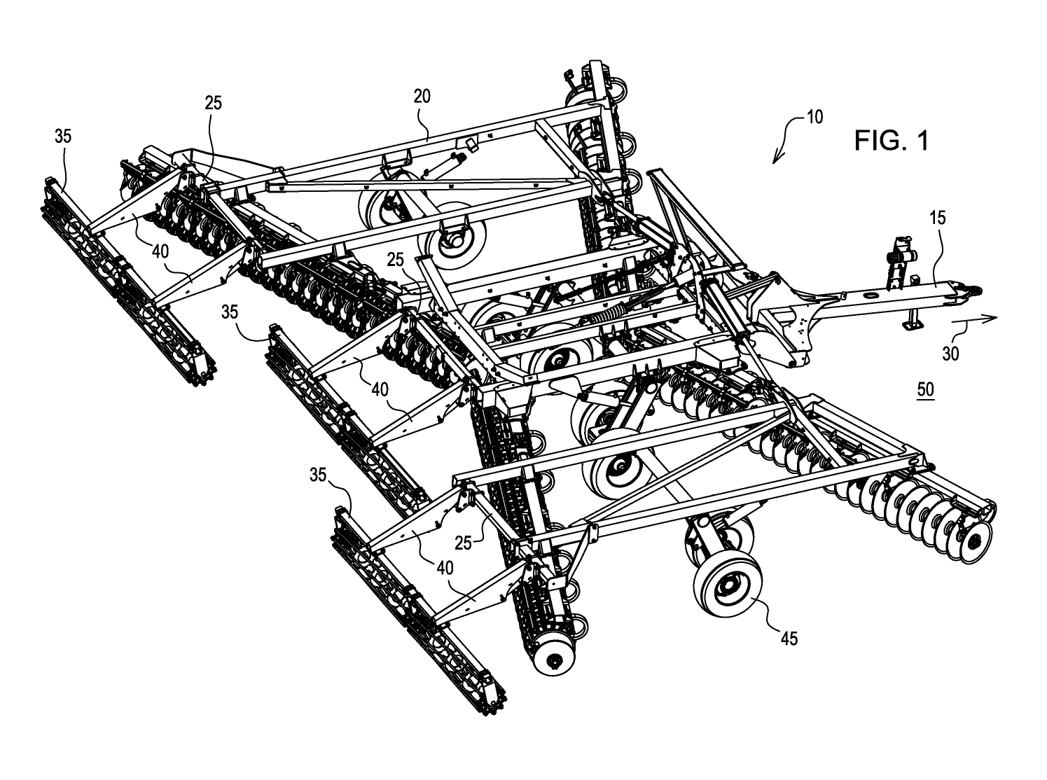

FIG. 1 illustrates an agricultural implement 10. The illustrated agricultural implement 10 includes a coupling mechanism 15 for coupling to a vehicle (not shown).

A frame 20 having a plurality of primary tool tubes 25 is coupled to the coupling mechanism 15. The frame 20 extends rearwardly from the coupling mechanism 15 in a direction opposite of a direction of travel 30. A plurality of secondary tool tubes 35 are coupled to a plurality of drawbars 40 that couple to the primary tool tubes 25. A plurality of wheel assemblies 45 are coupled to the frame 20. The wheel assemblies 45 support the frame 20 above a surface 50.

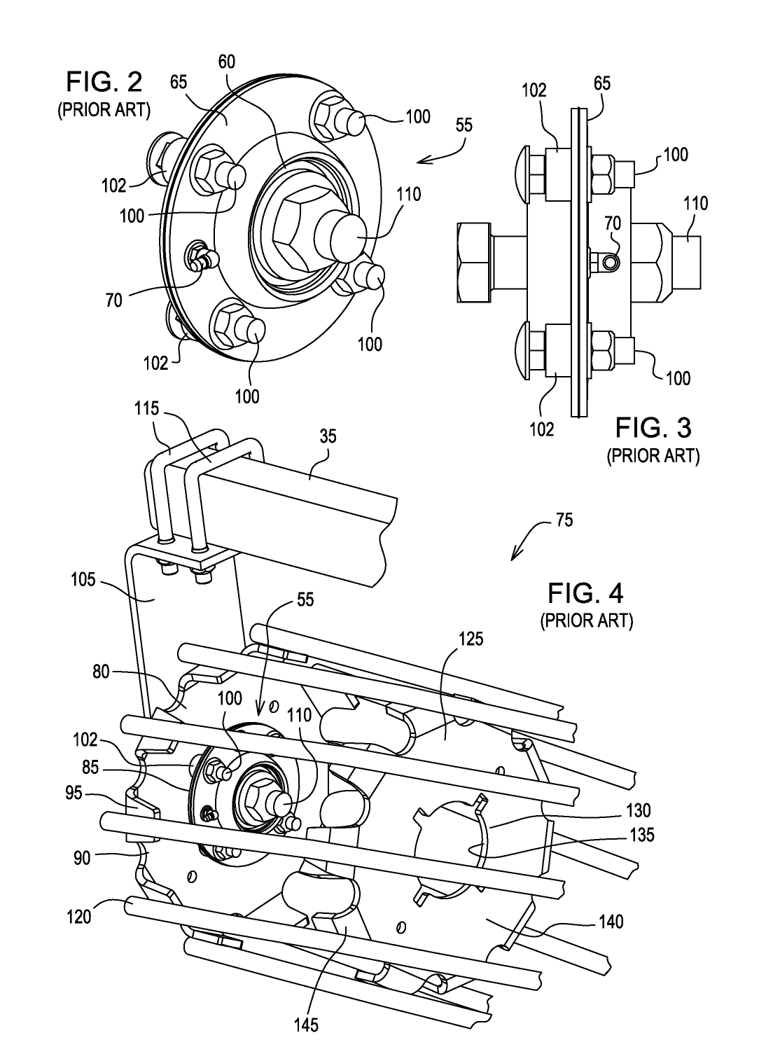

Referring to FIGS. 2 and 3, a prior art bearing assembly 55 is shown. The prior art bearing assembly 55 includes a prior art bearing 60 having a prior art central bearing aperture (not shown) that is retained by a stamped flangette housing 65. The stamped flangette housing 65 has a grease fitting 70.

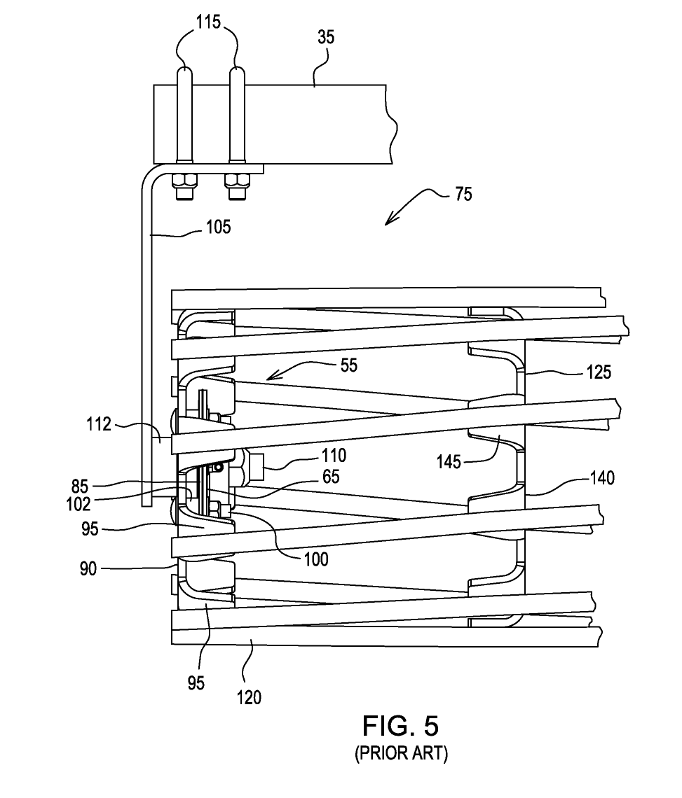

FIGS. 4 and 5 illustrate a prior art rolling basket 75 including a prior art end support 80. The prior art end support 80 has a prior art end support center portion 85 with a prior art end support center portion aperture (not shown) and a prior art end support periphery 90 with a plurality of prior art end support mounting tabs 95. The prior art bearing assembly 55 is coupled to the prior art end support center portion aperture with a plurality of first fasteners 100 that pass through the prior art end support, through a plurality of prior art bearing spacers 102, and through the stamped flangette housing 65.

A prior art mounting bracket 105 is coupled for rotation with the prior art central bearing aperture using a second fastener 110. The second fastener 110 passes through the prior art mounting bracket 105, through a spacer 112, and through the central bearing aperture. The prior art mounting bracket 105 is coupled to the secondary tool tube 35 with a plurality of u-bolt fasteners 115.

A plurality of ground-engaging bars 120 having a round cross-section are supported by the prior art end support mounting tabs 95. The ground-engaging bars 120 are also supported by a prior art inner support 125.

The prior art inner support 125 has a prior art inner support center portion 130 with a prior art inner support center portion aperture 135 and a prior art inner support periphery 140 with a plurality of prior art inner support mounting tabs 145. The prior art inner support mounting tabs 145 support the ground-engaging bars 120.

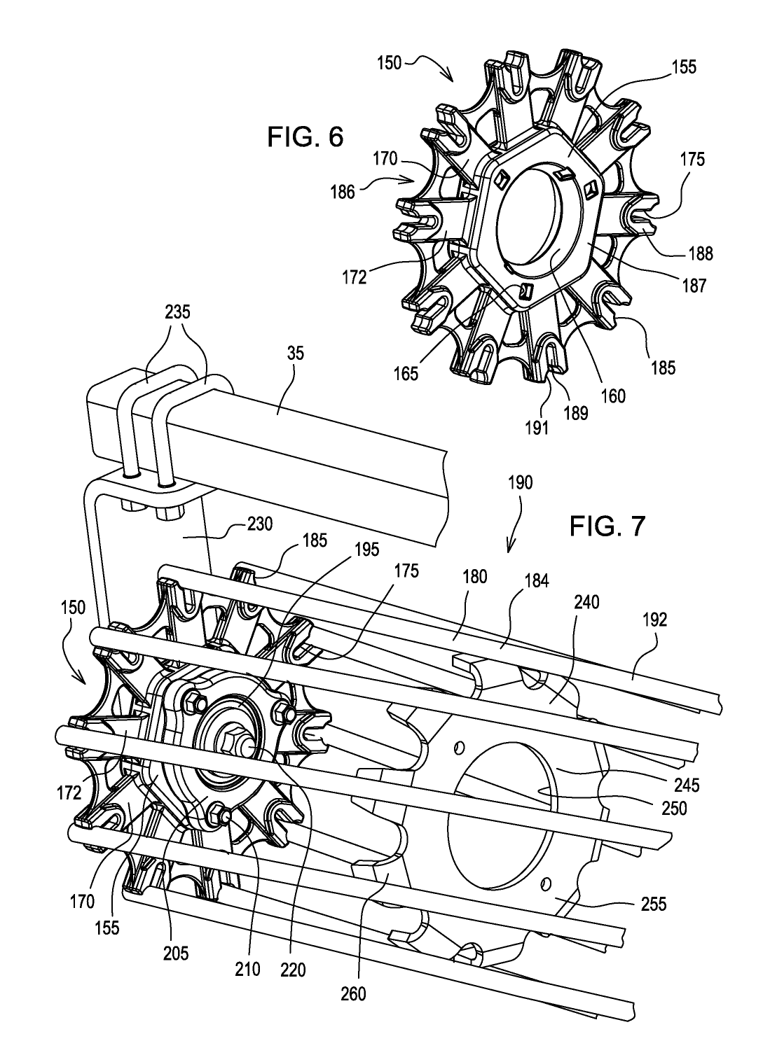

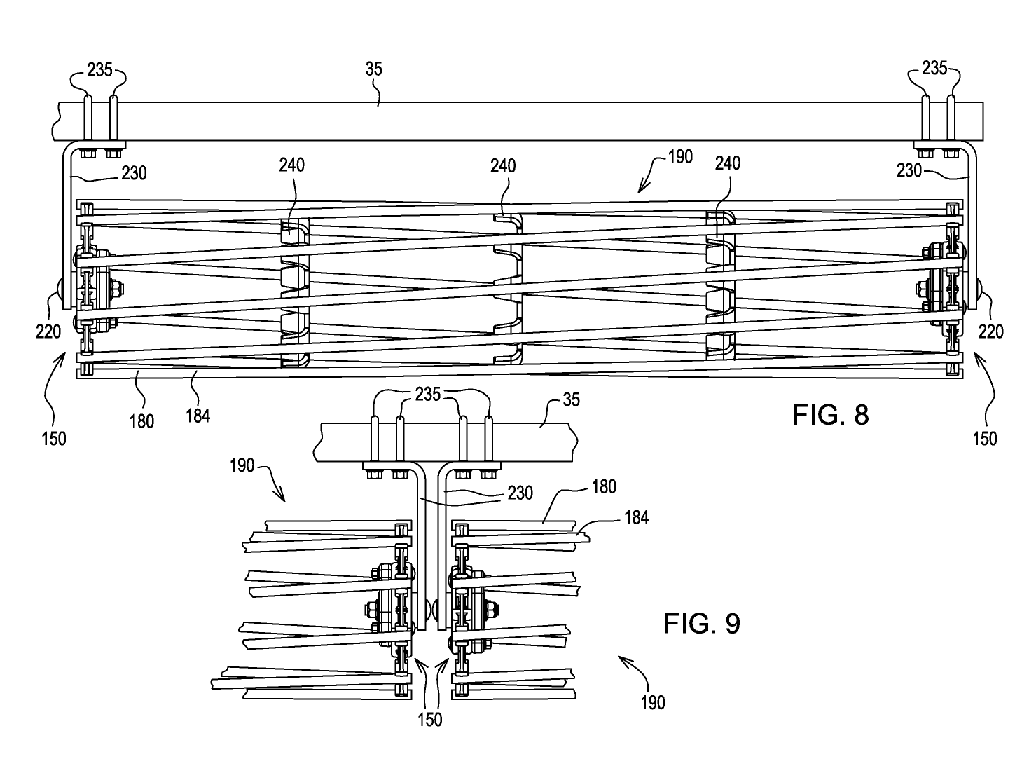

FIGS. 6-11 illustrate a rolling basket support 150 according to the present disclosure. Referring to FIG. 6, the rolling basket support 150 includes a rolling basket support center portion 155 having a bearing mount 160 and a plurality of apertures 165. The bearing mount 160 is integral with the rolling basket support 150. A rolling basket support periphery 170 extends radially around the bearing mount 160. The rolling basket support center portion 155 is coupled to the rolling basket support periphery 170 by a plurality of spokes 172. The rolling basket support 150 may be a one-piece symmetric casting.

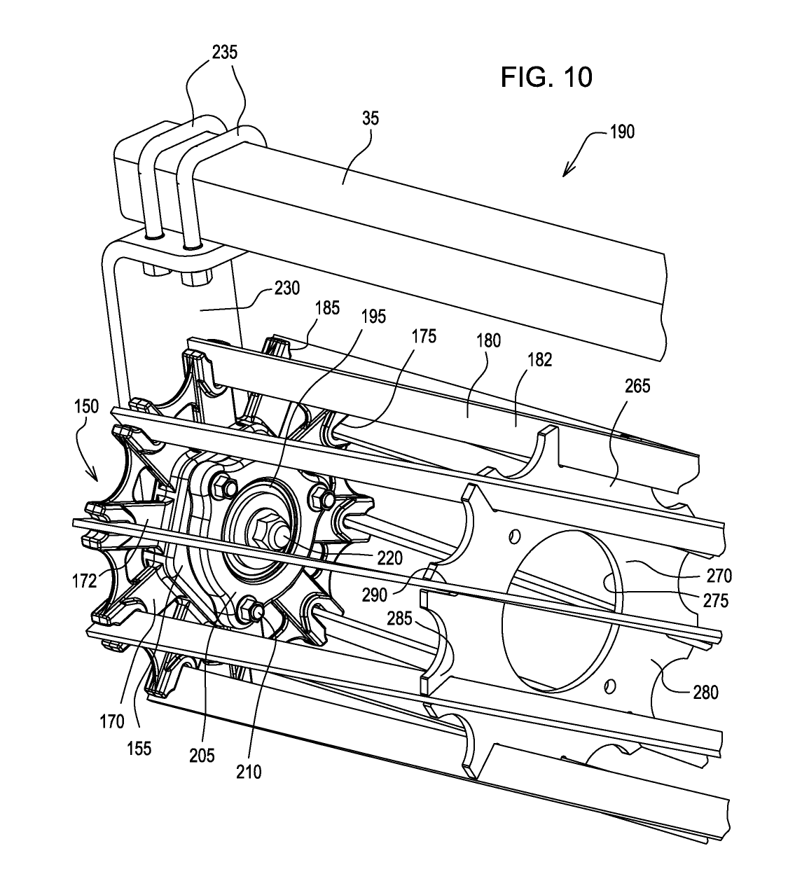

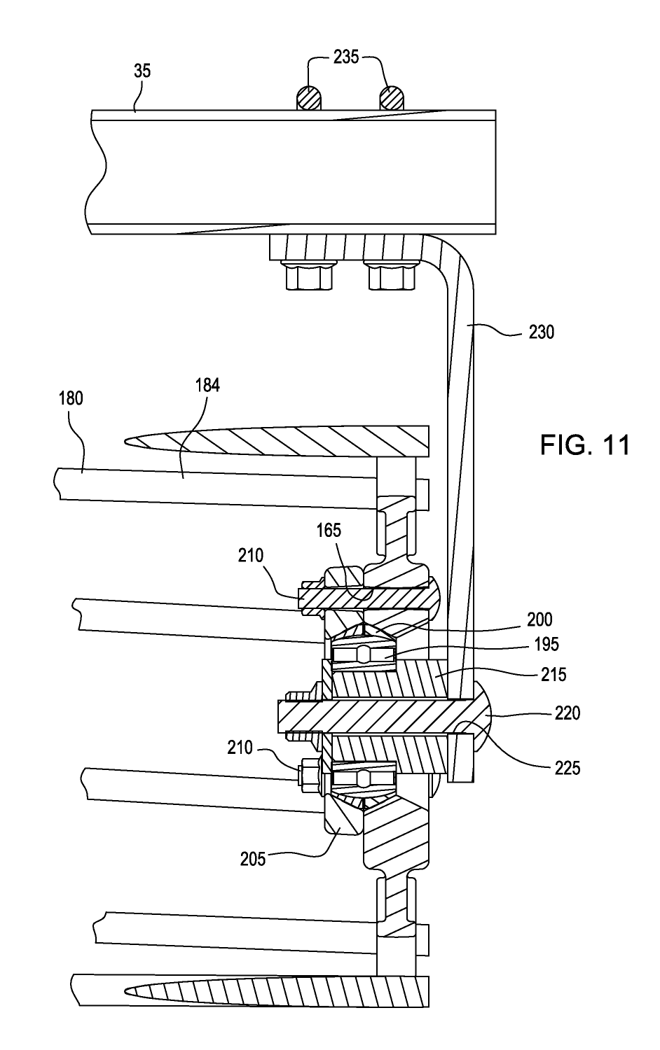

The rolling basket support periphery 170 has a radially inner notch 175 for coupling to ground-engaging bars 180 of a first cross-section and a radially outer notch 185 for coupling to ground-engaging bars 180 of a second cross-section. The first cross-section is flat and flat ground-engaging bars 182 (FIG. 10) may be coupled to the radially inner notch 175. The second cross-section is round and round ground-engaging bars 184 (FIG. 7) may be coupled to the radially outer notch 185. Alternatively, the first and second cross-sections may be flat, round, or other shapes.

Thus, with reference to FIG. 6, the rolling basket support 150 includes a disk member 186 having an inner portion 187 and an outer portion 188. The outer portion 188 has a plurality of first slots 189 formed therein, and the outer portion 188 has a plurality of second slots 191 formed therein. Each first slot 189 is adapted to hold a ground-engaging member 192 (FIG. 7) having a first cross-sectional shape, and each second slot 191 is adapted to hold a ground-engaging member having a second cross-sectional shape. Preferably, each first slot 189 is positioned radially inwardly with respect to a corresponding one of the second slots 191.

FIGS. 7-11 illustrate a rolling basket 190 including the rolling basket support 150. A bearing 195 is coupled to the bearing mount 160. The bearing 195 may be a maintenance free sealed bearing. Referring to FIG. 11, a bearing liner 200 is coupled to the bearing 195. A bearing cap 205 is coupled to the center portion 155 with a plurality of fasteners 210 that are received by the apertures 165. The bearing cap 205 may be a casting. A bushing 215 is coupled to the bearing 195. A fastener 220 is received by the bushing 215 and couples, for rotation, the rolling basket support 150 to an aperture 225 of a mounting bracket 230. The fastener 220 may be a carriage head bolt. The mounting bracket 230 is coupled to the secondary tool tube 35 with a plurality of u-bolt fasteners 235.

With reference to FIG. 7, the round ground-engaging bars 184 are also supported by a round inner support 240. The round inner support 240 has a center portion 245 with an aperture 250 and a periphery 255 with a plurality of mounting tabs 260. The mounting tabs 260 support the round ground-engaging bars 184.

With reference to FIG. 10, the flat ground-engaging bars 182 are also supported by a flat inner support 265. The flat inner support 265 has an inner support center portion 270 with an aperture 275 and a periphery 280 with a plurality of mounting tabs 285. Each mounting tab 285 has a slot 290. The slots 290 support the flat ground-engaging bars 182.

In operation, the rolling basket support 150 with integral bearing mount 160 enables at least two rolling baskets 190 to be coupled to the agricultural implement 10 in close proximity to one another (FIG. 9). This mounting configuration enables the rolling baskets 190 to occupy the majority of the width of the agricultural implement 10, which reduces the amount of soil that is not conditioned for each pass of the vehicle and agricultural implement 10. The maintenance free bearing 195 does not require a grease fitting.

While the disclosure has been illustrated and described in detail in the drawings and foregoing description, such illustration and description is to be considered as exemplary and not restrictive in character, it being understood that illustrative embodiments have been shown and described and that all changes and modifications that come within the spirit of the disclosure are desired to be protected. It will be noted that alternative embodiments of the present disclosure may not include all of the features described yet still benefit from at least some of the advantages of such features. Those of ordinary skill in the art may readily devise their own implementations that incorporate one or more of the features of the present disclosure and fall within the spirit and scope of the present invention as defined by the appended claims. For example, the round bar holding slots could be positioned between adjacent pairs of the flat bar holding slots.

Various features are set forth in the following claims.

What is claimed is:

1. A rolling basket support for coupling a rolling basket to an agricultural implement, the rolling basket support comprising:
a center portion comprising a bearing mount; and
a periphery extending radially around the bearing mount;
wherein the periphery comprises a radially inner notch for coupling to ground-engaging bars of a first cross-section and a radially outer notch for coupling to ground-engaging bars of a second cross-section.

2. The rolling basket support of claim 1, wherein the ground-engaging bars are flat and couple to the radially inner notch.

3. The rolling basket support of claim 1, wherein the ground-engaging bars are round and couple to the radially outer notch.

4. The rolling basket support of claim 1, further comprising a plurality of spokes coupling the center portion to the periphery.

5. The rolling basket support of claim 1, further comprising a bearing coupled to the bearing mount.

6. The rolling basket support of claim 5, further comprising a bearing cap coupled to the center portion, the bearing cap configured to retain the bearing.

7. The rolling basket support of claim 6, further comprising a bushing coupled to the bearing.

8. The rolling basket support of claim 7, further comprising a fastener received by the bushing and coupling the rolling basket support to the agricultural implement.

9. A rolling basket support for coupling a rolling basket to an agricultural implement, the rolling basket support comprising:
a center portion comprising a bearing mount;
a plurality of spokes coupled to the center portion; and
a periphery coupled to the spokes;
wherein the periphery comprises a radially inner notch for coupling to ground-engaging bars of a first cross-section and a radially outer notch for coupling to ground-engaging bars of a second cross-section.

10. The rolling basket support of claim 9, wherein the ground-engaging bars are flat and couple to the radially inner notch.

11. The rolling basket support of claim 9, wherein the ground-engaging bars are round and couple to the radially outer notch.

12. The rolling basket support of claim 9, further comprising a bearing coupled to the bearing mount.

13. The rolling basket support of claim 12, further comprising a bearing cap coupled to the center portion, the bearing cap configured to retain the bearing.

14. The rolling basket support of claim 13, further comprising a bushing coupled to the bearing.

15. The rolling basket support of claim 14, further comprising a fastener received by the bushing and coupling the rolling basket support to the agricultural implement.

16. An agricultural implement comprising:
a coupling mechanism for coupling to a vehicle;
a frame comprising a tool tube coupled to the coupling mechanism and extending from the coupling mechanism and adapted to be pulled by the vehicle in a direction of travel;
a plurality of wheel assemblies coupled to the frame, the wheel assemblies supporting the frame above a surface; and
a rolling basket comprising a rolling basket support for coupling the rolling basket to the tool tube, the rolling basket support comprising a center portion comprising a bearing mount, and a periphery extending radially around the bearing mount;
wherein the periphery comprises a radially inner notch for coupling to ground-engaging bars of a first cross-section and a radially outer notch for coupling to ground-engaging bars of a second cross-section.

17. The agricultural implement of claim 16, wherein the ground-engaging bars are flat and couple to the radially inner notch.

18. The agricultural implement of claim 17, wherein the ground-engaging bars are round and couple to the radially outer notch.

19. The agricultural implement of claim 18, further comprising a bearing coupled to the bearing mount.

20. The agricultural implement of claim 19, further comprising a bearing cap coupled to the center portion, the bearing cap configured to retain the bearing.

21. A rolling basket support for rotatably coupling a rolling basket to a frame, the rolling basket support comprising:
a disk member comprising an inner portion and an outer portion, the outer portion comprising a plurality of first slots formed therein, and the outer portion comprising a plurality of second slots formed therein, each first slot being adapted to hold a ground-engaging member having a first cross-sectional shape, each second slot being adapted to hold a ground-engaging bar having a second cross-sectional shape.

22. The rolling basket support of claim 21, wherein each first slot is positioned radially inwardly with respect to a corresponding one of the second slots.
